(19) United States
(12) Patent Application Publication
(10) Pub. No.: US 2018/0025352 A1
(43) Pub. Date: Jan. 25, 2018

(54) SINGLE USE QR CODE AUTHORIZATION SYSTEM

(71) Applicant: Larry J. Kane, Hiawatha, IA (US)

(72) Inventor: Larry J. Kane, Hiawatha, IA (US)

(21) Appl. No.: 15/679,230

(22) Filed: Aug. 17, 2017

Related U.S. Application Data
(63) Continuation of application No. 13/796,267, filed on Mar. 12, 2013, now abandoned.

(51) Int. Cl. G06Q 20/38; G06Q 20/32

(52) U.S. Cl. CPC G06Q 20/385; G06Q 20/3274

(57) ABSTRACT

An electronic secured payment system where a single use QR Code is assigned to a consumer account, displayed on a consumer's electronic device, and scanned by a merchant's device to permit a merchant to access and verify the consumer's account and enter transaction information.

### CROSS REFERENCE TO A RELATED APPLICATION

This application is a continuation of U.S. patent application Ser. No. 13/796,267 filed on Mar. 12, 2013.

### BACKGROUND OF THE INVENTION

This invention is directed to a secured payment system, and more particularly a secured payment system that utilizes a Single use QR Code.

With the advent of electronic devices such as SmartPhones and I-Pads, making payments or other transactions using these portable devices is becoming more popular. While these devices enhance the ease of making a payment, the devices do not have security provisions to avoid payment fraud and ensure that an individual making a purchase is authorized to do so through the electronic device. Thus, a system is needed that addresses this need in the art.

An objective of the present invention is to provide a payment system that utilizes a single use QR Code.

Another objective of the present invention is to provide a secured transaction system for use with SmartPhones, I-Pads, and the like.

These and other objectives will be apparent to those skilled in the art based upon the following written description, drawings and claims.

### SUMMARY OF THE INVENTION

A system for making a secured electronic transaction wherein a single use QR Code, which contains both static information as well as a random code, is displayed on a consumer's electronic device. The QR Code is scanned by a merchant to permit access to the consumer's account so as to verify that the consumer is authorized to make a transaction. If accepted, the merchant enters transaction information and a transaction confirmation is transmitted.

### BRIEF DESCRIPTION OF THE DRAWINGS

FIG. 1 is a schematic view of an environment for a payment system; and

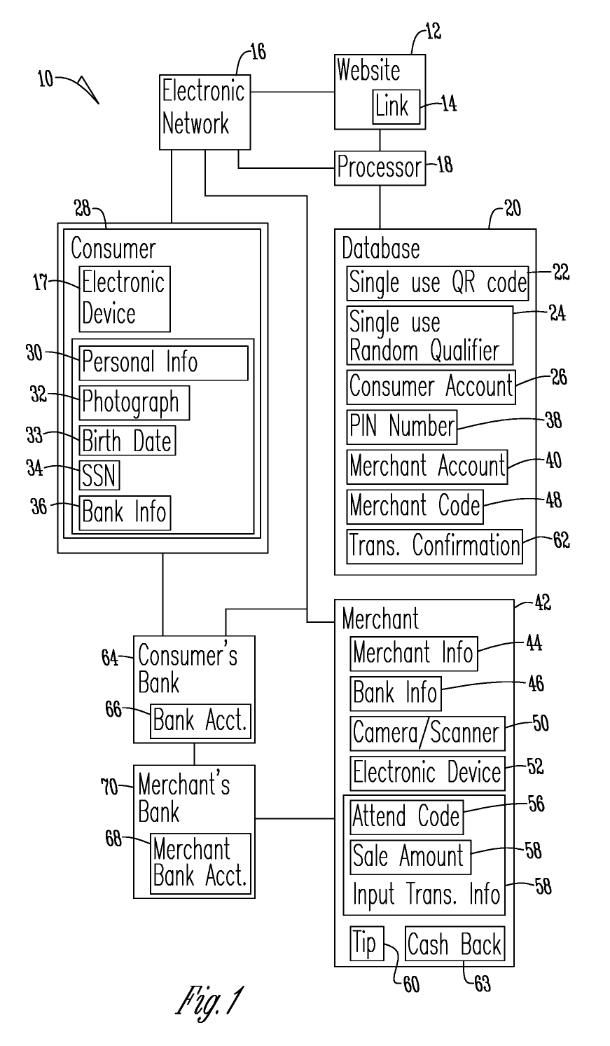

FIG. 2 is a flow diagram of a method for making a secured payment.

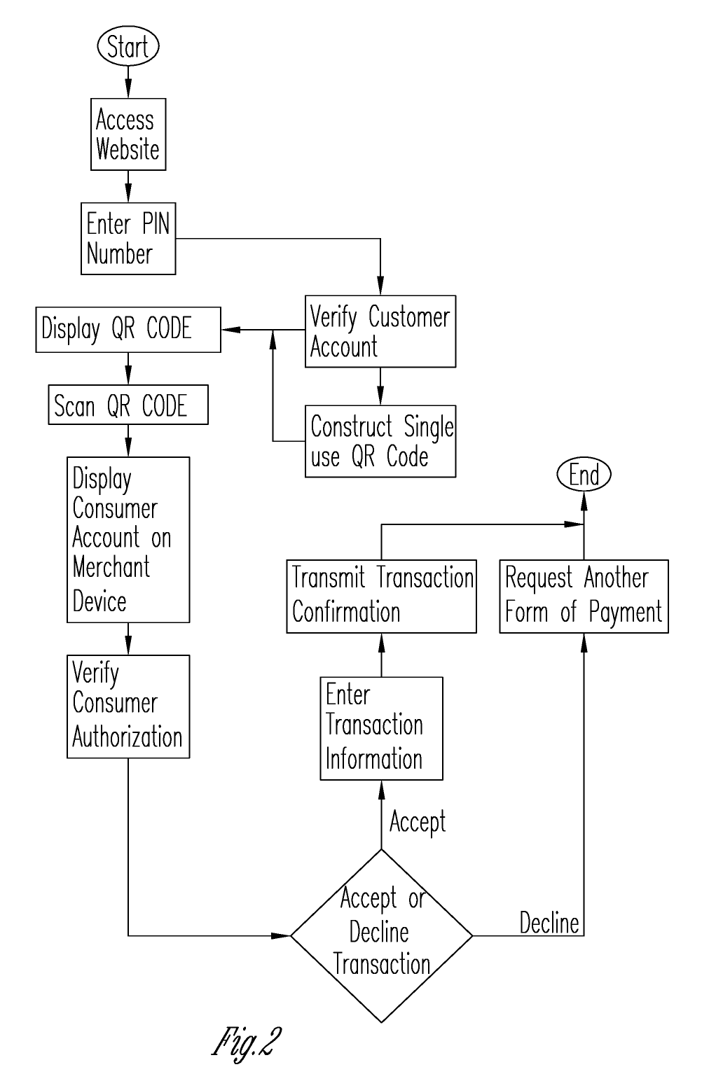

### DETAILED DESCRIPTION OF THE PREFERRED EMBODIMENTS

Referring to the Figures, a secured payment system 10 and method of using the same includes a website 12 having a link 14. The website 12 is connected to an electronic network 16 and a processor 18 which is connected to a database 20. Temporarily stored within the database is a single use random qualifier 24, which is constructed when a transaction request is initiated, and is used to construct a single use Quick Response (QR) or single use code 22. A QR Code is a two-dimensional code as described in U.S. Pat. Nos. 5,726,435 and 7,032,823, presently assigned to Denso Wave, Inc., which are both hereby incorporated. The single use QR Code 22 includes the link 14.

To establish a consumer account 26, a consumer 28 accesses the website 12 via the electronic network 16 through an electronic device 17 such as a SmartPhone, I-Pad or the like and provides personal information 30 that may include a photograph 32 of the consumer, the consumer's birth date 33 and Social Security Number 34, and the consumer's bank information 36. Upon receipt of the personal information 30, the system 10 issues a PIN number 38, which the consumer 28 may change upon request. The PIN number 38 is associated with the consumer's 28 personal information 30 and both are stored within the database 20.

To establish a merchant account 40, a merchant 42 provides merchant information 44 that includes merchant bank information 46. Once received, the system 10 issues a merchant code 48 to the merchant 42.

To conduct a transaction, a consumer 28 accesses the system 10 through a link 14 which preferably is stored in the browser favorites of the consumer's 28 electronic device 17. The consumer 28 then enters the PIN number 38 and provided the entered PIN number 38 matches the stored PIN number 38, the system 10 constructs and transmits a single use QR Code 22 which is displayed on the consumer's 28 electronic device 17. The QR Code 22 contains both static information as well as one-time random information 24. If the system does not receive a transaction within a specific amount of time, the one-time random information 24 is erased from the system, rendering the QR Code 22 invalid. The specific amount of time may be determined by the issuer of the single use QR Code 22.

Once displayed, the merchant 42 captures a photo or scan of the QR Code 22 which causes the consumer's account 26 to be displayed on the merchant's 42 electronic device 52. Included on the displayed consumer account 26 is the consumer's photo 32 so the merchant can match it to the consumer.

Once verified, the merchant enters the merchant code 48, the attendant's name or code 56, and the amount of the sale 58 into electronic device 52. The inputted transaction information 58 is transmitted via the electronic network 16 to the system 10. The system compares the one time random code 24 from the transaction to the code 24 previously generated by the system. If they do not match, the transaction is declined, and the QR Code is invalid. If accepted, the system 10 transmits and displays the transaction information 58 to the merchant's electronic device 52 where the consumer 28 may input a tip 60 or a cash back amount 63 and enter the consumer PIN number 38 and the merchant may accept or decline the transaction. If accepted, the system 10 receives an acceptance signal and then transmits for display a transaction confirmation 62 to the consumer's device 17 and/or the merchant's electronic device 52. If declined, the system prompts the merchant through a displayed message 64 to have the consumer provide another form of payment.

For an accepted transaction, the processors 18 send a signal to the consumer's bank 64 that authorizes a transfer of funds from the consumer's bank account 66 to the merchant's bank account 68 at the merchant's bank 70. Also, once used, the single use random code 24 is erased from the system so that the QR Code cannot be used again.

What is claimed is:

1. A system for making a secured transaction, comprising:
a website having a link connected to a processor via an electronic network;
a database connected to the processor;
a single use random qualifier temporarily stored within the database;
a consumer account associated with personal information of a consumer including a photograph of the consumer and a personal identification number stored in the database;
a single use code having the link including the single random qualifier and displayed on a consumer's electronic device entry of the personal identification by a consumer; and
wherein, upon capturing the displayed single use code by a merchant, the consumer account, including the photo of the consumer, is displayed on the merchant's electronic device.

2. A method for making a secured electronic payment comprising the steps of:
establishing a consumer account by accessing a website via an electronic network and providing personal information including a photo of a consumer through a consumer's electronic device;
storing a temporary single use random qualifier in a database connected to a processor that is connected to the website via the electronic network;
constructing a single use code that includes a link to the website and the single use random qualifier by the processor upon initiation of a transaction;
transmitting the constructed single use code to the consumer's electronic device and displaying the constructed single use code on the consumer's electronic device; and
capturing the displayed single use code and displaying the consumer's account including the photo of the consumer on the merchant's electronic device.

3. The method of claim 2 further comprising the step of inputting a tip amount by the consumer.

4. The method of claim 2 further comprising the step of inputting a cashback amount by the consumer.

5. The method of claim 2 further comprising the step of accepting a transaction by the merchant.

6. The method of claim 2 further comprising the step of declining a transaction by the merchant.

7. The method of claim 6 further comprising the step of authorizing a transfer of funds from a consumer's bank account to a merchant's bank account upon acceptance of a transaction.
